(19) United States
(12) Patent Application Publication
(10) Pub. No.: US 2018/0029298 A1
(43) Pub. Date: Feb. 1, 2018

(54) DATA STRUCTURE OF 3D OBJECT AND 3D DATA MANAGEMENT APPARATUS

(71) Applicant: CANON KABUSHIKI KAISHA, Tokyo (JP)

(72) Inventors: Satomi Takaya, Kamo-gun (JP); Tsunehiro Tsukada, Yokohama-shi (JP)

(21) Appl. No.: 15/556,906

(22) PCT Filed: Mar. 3, 2016
(86) PCT No.: PCT/JP2016/001171

§ 371 Date: Sep. 8, 2017

(30) Foreign Application Priority Data
Mar. 11, 2015 (JP) 2015-048190

(51) Int. Cl. B29C 64/386; G05B 19/4099; B33Y 50/00

(52) U.S. Cl. CPC B29C 64/386; B33Y 50/00; G05B 19/4099; G05B 2219/49023

(57) ABSTRACT

The present invention provides a technique for improving convenience in the use and management of 3D data. The present invention is a data structure of a 3D object for managing information related to a three dimensional structure of an object including input data as data on the 3D object generated by a 3D input apparatus, structure data as data representing the three dimensional structure of the 3D object that is generated from the input data, and shape data as data obtained by performing, on the structure data, processing required to meet a required specification of a specific 3D shaping apparatus.

### TECHNICAL FIELD

The present invention relates to a technique for using and managing 3D data.

### BACKGROUND ART

In recent years, 3D (three dimensional) techniques attract great attention. One of the techniques is a 3D shaping apparatus that uses a 3D shaping technique called additive manufacturing, 3D printing, or rapid prototyping. In addition, a 3D display apparatus that outputs 3D images is expected to be applied to various fields such as VR (Virtual Reality) and MR (Mixed Reality). In the present description, these apparatuses are collectively referred to as a 3D output apparatus.

On the other hand, as an apparatus that inputs or generates 3D data, a measurement apparatus such as a 3D scanner that measures the shape of a 3D object and a system such as a 3D CAD or a 3D modeler that generates the 3D shape on a computer are used. In the present description, these apparatuses are collectively referred to as a 3D input apparatus.

Incidentally, “3D data” has various data formats. For example, data that is usually obtained by the 3D scanner is point cloud data of an object surface, while the output of the 3D-CAD is CAD data or modeling data. In addition, even between the 3D input apparatuses of the same type, when their makers or models are different, their data items don't have compatibility in many cases. Similarly, in the 3D output apparatus that uses the 3D data, an acceptable data format usually differs from one maker or model to another. Further, required accuracy and condition of the 3D data differ depending on the use purpose (shaping or display) and shaping method of the 3D data. For example, in the case of data for shaping, unlike data for display, it is necessary to give a thickness to a pillar and a wall (structural strength), and a structural fault (a gap, a discontinuous part, or the like) should not exist. In addition, a structure depending on the shaping method (a support structure, a lightening hole, or the like) should be considered.

Consequently, it is difficult to transfer data obtained by the 3D input apparatus to the 3D output apparatus without altering the data, and it becomes necessary to perform a processing operation in which data format conversion is performed in correspondence to required specifications of the 3D output apparatus or appropriate correction is performed.

As an example, operation procedures in the case where the point cloud data of the 3D scanner is output to the 3D shaping apparatus will be described. First, the point cloud data is converted to data representing the 3D structure of an object surface (polygon data or the like). In the case where the structural fault (the gap or the discontinuous part) is included in the conversion result, the data is corrected appropriately. Thereafter, the thickness is given to the pillar or the wall, and the support structure or the lightening hole is added in correspondence to the required specifications and the shaping method of the 3D shaping apparatus to which the data is to be output. Subsequently, the 3D data after the processing is converted to slice data having a plurality of layers, and the slice data is output to the 3D shaping apparatus.

Software dedicated to data processing is included in or attached to the typical 3D shaping apparatus, and it is possible to perform special processing corresponding to the shaping apparatus or the shaping method and the conversion process to the slice data by using the software. However, the processing operation of the 3D data requires high-level knowledge and skill and also takes great time, and hence automation of the operation and cost saving are challenges to be solved.

As conventional arts for simplifying the use and processing of the 3D data, the arts described in PTLs 1 and 2 are well-known. PTL 1 proposes a technique for efficiently generating and using a 3D model based on input 3D-CAD data. PTL 2 proposes a conversion apparatus that acquires characteristics of the 3D shaping apparatus to which the 3D data is to be output and generates the slice data for shaping from the 3D data based on the characteristics.

### CITATION LIST

### Patent Literature

### [PTL 1]

### Japanese Patent Application Laid-open No. 2006-4200

### [PTL 2]

### Japanese Patent Application Laid-open No. 2012-101443

### SUMMARY OF INVENTION

### Technical Problem

The 3D data after the processing or the slice data is data that depends on the device to which the data is to be output, and has no multiplicity of use. Consequently, in the case where data on the same object is output to another device, it is necessary to perform operations such as data conversion and correction from the beginning by using the original 3D data. In addition, when the operation details of previously performed the processing/the correction are forgotten or the original 3D data is lost, there are cases where it is difficult to reproduce the same object.

In addition, in the case where a data error is detected during an output (e.g., during shaping in the 3D shaping apparatus) in spite of the fact that the data processing has been performed over long time, it is necessary to suspend the output and reconstruct the data for the output from the original 3D data again so that working efficiency is low.

The present invention has been made in view of the above circumstances, and an object thereof is to provide a technique for improving convenience in the use and management of 3D data.

### Solution to Problem

A first aspect of the present invention provides a data structure of a 3D object for managing information related to a three dimensional structure of an object including input data as data on the 3D object generated by a 3D input apparatus, structure data as data representing the three dimensional structure of the 3D object that is generated from the input data, and shape data as data obtained by performing, on the structure data, processing required to meet a required specification of a specific 3D shaping apparatus.

Further features of the present invention will become apparent from the following description of exemplary embodiments with reference to the attached drawings.

### BRIEF DESCRIPTION OF DRAWINGS

FIG. 1 is a view for explaining an outline of a 3D data management apparatus.

FIG. 2 is a view showing a functional configuration of the 3D data management apparatus.

FIG. 3 is a view showing a data structure of a project.

FIG. 4A is a view showing a part of a data structure of metadata (property) of the project.

FIG. 4B is a view showing a part of a data structure of metadata (property) of the project.

FIG. 4C is a view showing a part of a data structure of metadata (property) of the project.

FIG. 5A is a part of a view showing a data structure of metadata (property) of a 3D model.

FIG. 5B is a view showing a part of a data structure of metadata (property) of a 3D model.

FIG. 5C is a view showing a part of a data structure of metadata (property) of a 3D model.

FIG. 5D is a view showing a part of a data structure of metadata (property) of a 3D model.

FIG. 5E is a view showing a part of a data structure of metadata (property) of a 3D model.

FIG. 6 is a flowchart showing an example of an operation of the 3D data management apparatus.

### DESCRIPTION OF EMBODIMENTS

<3D Data Management Apparatus>

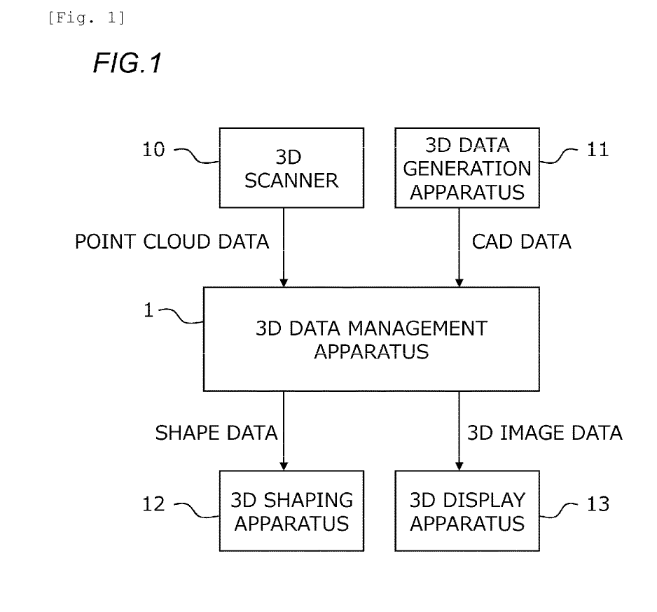

First, the role and object of a 3D data management apparatus according to an embodiment of the present invention will be described with reference to FIG. 1.

There are various devices that handle 3D data. Examples of a 3D input apparatus include a 3D scanner 10 that measures the shape of a 3D object, and a 3D data generation apparatus 11 such as a 3D-CAD or a 3D modeler that generates a 3D shape on a computer. In addition, as a 3D output apparatus, there are a 3D shaping apparatus 12 such as a 3D printer and a 3D display apparatus 13 of VR (Virtual Reality) or MR (Mixed Reality). As has been described in Background Art, there are various data formats of the 3D data handled in these devices, and the accuracy and condition required of the 3D data differ depending on the use purpose and shaping method of the 3D data.

A 3D data management apparatus 1 is a system that provides a function of performing data conversion and processing/correction on various 3D data items handled in various devices, and also provides a function of collectively managing data before and after the processing and information on an operation history. With this, it becomes possible to provide convenience with which the 3D data is easily handled without high-level knowledge or skill to a user, and implement a cooperation between devices with the 3D data management apparatus 1 used as a nucleus and an integrated work flow related to the input-processing-output of the 3D data.

<System Configuration>

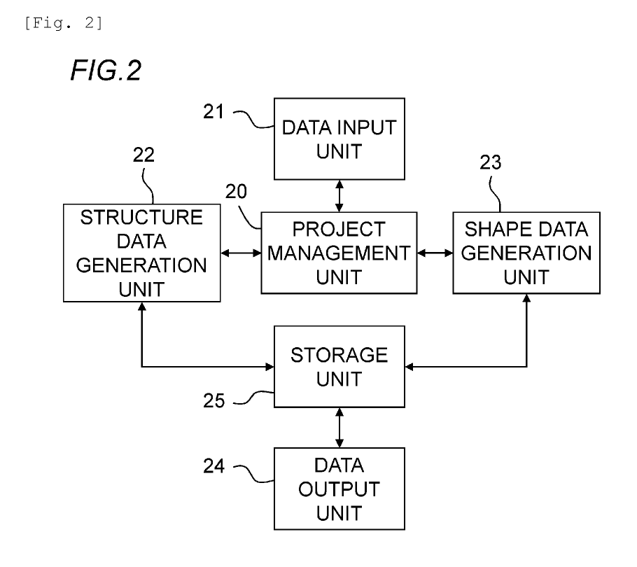

FIG. 2 schematically shows a functional configuration of the 3D data management apparatus 1. The 3D data management apparatus 1 has a project management unit 20, a data input unit 21, a structure data generation unit 22, a shape data generation unit 23, a data output unit 24, and a storage unit (database) 25 as main functions.

The 3D data management apparatus 1 of the present embodiment manages all information related to one 3D object by using a unit (data set) called “project”. The data structure of the project will be described later. The project management unit 20 has a function of performing new generation of the project, registration/update/deletion of data in the project, registration/update/deletion of metadata described later, and read of data in the project. Note that the entity of the data of the project is stored in the storage unit 25.

The data input unit 21 has a function of acquiring data on the 3D object. Examples of a data acquisition source include the 3D scanner 10 and the 3D data generation apparatus 11 shown in FIG. 1. Alternatively, the data on the 3D object may also be acquired from a storage medium, another computer, an external storage, and a server. Hereinafter, the data on the 3D object acquired by the data input unit 21 (original data) is referred to as “input data”. The format of the input data may be any format. Examples of the representative input data include point cloud data obtained by the 3D scanner 10 (data in which 3D coordinate values of a plurality of dots on the surface of the 3D object are described), and CAD data of IGES or STEP obtained by the 3D data generation apparatus 11. In addition, polygon data generated by the 3D scanner 10 or the 3D data generation apparatus 11 can also be used as the input data.

The structure data generation unit 22 has a function of generating data representing the three dimensional structure of the 3D object (hereinafter referred to as “structure data”) based on the input data. In the present embodiment, as the structure data, polygon data in which the surface profile of the 3D object is represented by a polygon mesh is used. The polygon data is, e.g., data in which 3D coordinate values of the vertexes of each polygon and information on the front and the back of each polygon (a normal vector or the like) are described, and its specific format may be any format. Examples of the representative polygon data include STL (Stereolithography) and AMF (Additive Manufacturing File). The structure data needs to be data in a state in which there is no failure of the three dimensional structure (mathematically correct). Consequently, in the case where a structural fault (a gap, a discontinuous part, or a topology error) has occurred when the input data is converted to the polygon or Make Face of the input data is performed, the fault is solved by performing re-conversion or manual correction. The structure data generation unit 22 also provides such a data correction function.

The shape data generation unit 23 has a function of performing processing required for outputting to the specific 3D shape shaping apparatus on the structure data. Data having been processed by the shape data generation unit 23 is referred to as “shape data”. The format of the shape data may be any format and, in the present embodiment, the polygon data is used similarly to the structure data. However, in addition to the polygon data representing the three dimensional structure of the 3D object, parameters used during shaping in the 3D shaping apparatus (shaping conditions, designation of color/material, 3D shaping apparatus control data, and the like) can be included. In addition, depending on the shaping method, a support structure for supporting an overhanging part of the 3D object serving as a shaping target is required, and hence the polygon data representing the structure of the support structure is also added to the shape data.

The data output unit 24 has a function of outputting various data items registered in the project to an external apparatus. For example, the data output unit 24 is capable of outputting the shape data to the 3D shaping apparatus, outputting the structure data to the 3D display apparatus, and exporting the input data/the structure data/the shape data to other editing software. Further, the data output unit 24 is also capable of outputting various data items registered in the project to the display apparatus.

The storage unit (database) 25 has a function of storing the entity of the data registered in the project. In addition, in the storage unit 25, a setting table consulted when the structure data and the shape data are generated is also stored. In the setting table, for example, an algorithm and a parameter when the structure data is generated, required specifications (required strength, necessity of the support structure, necessity of a lightening hole, and the like) for each model of the 3D shaping apparatus, required accuracy, shaping conditions, and materials are defined.

The 3D data management apparatus 1 can be constituted by a computer that includes, e.g., a CPU (central processing unit), a memory, an auxiliary storage apparatus (a hard disk, a flash memory, or the like), a keyboard, a pointing device, a display apparatus, and various I/Fs. The CPU reads and executes a program stored in the auxiliary storage apparatus or the like to control required hardware resources, and the individual functions shown in FIG. 2 are thereby implemented. However, part or all of the functions described above may be constituted by a circuit such as ASIC or FPGA, or may also be executed by another computer by using techniques such as cloud computing and grid computing.

<Data Structure of Project>

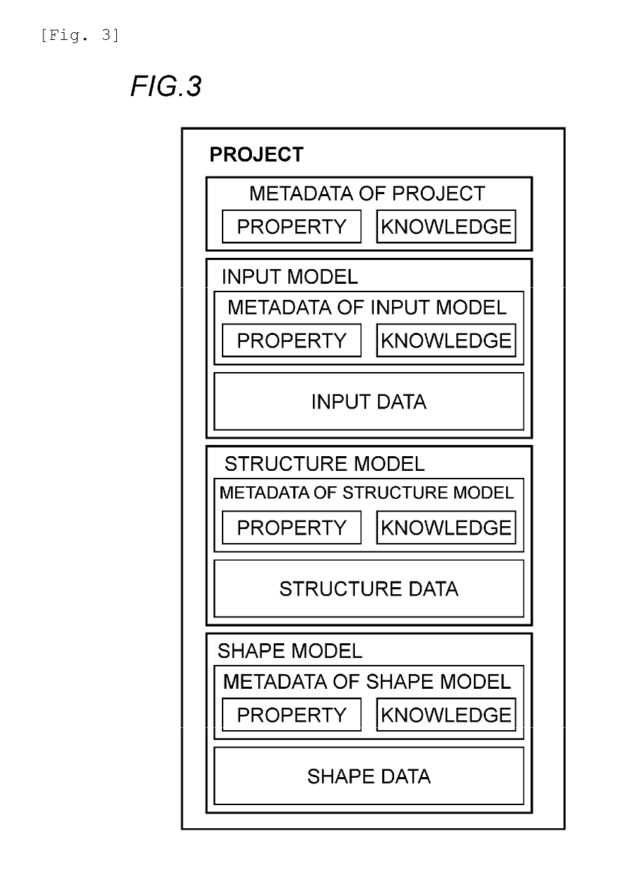

The data structure of the project will be described with reference to FIG. 3. FIG. 3 is a view showing an example of the data structure of the project.

As shown in FIG. 3, in the project, three models (an input model, a structure model, a shape model) are stored. In each model, data (3D data) and metadata as information for complementing the model are stored. In the metadata, two types of data items are broadly stored. One of them is “PROPERTY” as complementary data related to the 3D data itself, and the other one is “KNOWLEDGE” that includes history information of operations such as conversion, correction, and processing of the 3D data, and comment information input by a creator or an operator who has checked a detail. In addition, the metadata is stored in the project itself.

More specifically, in “METADATA (PROPERTY) OF PROJECT”, information related to the entire project, e.g., objective information items such as the time and date of generation of the project and the creator are stored. In “METADATA (KNOWLEDGE) OF PROJECT”, information on the operation related to the entire project, e.g., information such as cautions input by the operator involved in the project is stored.

In addition, “INPUT MODEL” includes “INPUT DATA” as the 3D data and “METADATA OF INPUT MODEL”. “INPUT DATA” is, e.g., the point cloud data generated by the 3D scanner or the CAD data generated by the 3D-CAD or the 3D modeler. In “METADATA (PROPERTY) OF INPUT MODEL”, complementary information related to the input data itself, e.g., the type of the input data and the used unit of length are stored. In “METADATA (KNOWLEDGE) OF INPUT MODEL”, cautions related to the input data, e.g., information on a part having a large scanning error or information on a part where a problem is likely to occur when conversion to the polygon or Make Face is performed are stored.

“STRUCTURE MODEL” includes “STRUCTURE DATA” as the 3D data and “METADATA OF STRUCTURE DATA”. “STRUCTURE DATA” is, e.g., the polygon data generated from the input data. In “METADATA (PROPERTY) OF STRUCTURE DATA”, complementary information related to the structure data itself, e.g., parameters used in the conversion to the structure data (the conversion to the polygon, Make Face, and the like) are stored. In “METADATA (KNOWLEDGE) OF STRUCTURE DATA”, history information of the operation of generating the structure data from the input data such as, e.g., a problem that has occurred when the input data is converted to the polygon, a method for solving the problem, and an unsolved problem is stored.

“SHAPE MODEL” includes “SHAPE MODEL” as the 3D data and “METADATA OF SHAPE DATA”. “SHAPE DATA” is, e.g., data that is adjusted to a level that allows shaping in a specific 3D shaping apparatus. That is, “SHAPE DATA” is data in a state in which not only the structural problem but also a shaping problem is solved. In “METADATA (PROPERTY) OF SHAPE DATA”, information related to the shape data itself such as, e.g., information on the 3D shaping apparatus designated as a 3D shaping apparatus to which the shape data is to be output, shaping conditions, information on the color/the material is stored. Note that these information items may be embedded in the shape data. In “METADATA (KNOWLEDGE) OF SHAPE DATA”, the history information of the operation of generating the shape data such as, e.g., a problem that has occurred when the shape data is generated from the structure data, a method for solving the problem, and an unsolved problem is stored.

Note that the data structure in FIG. 3 is only an example and the data structure of the project is not limited thereto. For example, the metadata is stored for each model in the example in FIG. 3, but the property and the knowledge of each model may also be stored in the metadata of the project. Further, in the case where the metadata can be embedded in the 3D data, it is not necessary to store the metadata in addition to the 3D data. In addition, 3D data other than the input data, the structure data, and the shape data (e.g., data for the 3D display apparatus) can be added into the project.

<Example of Property>

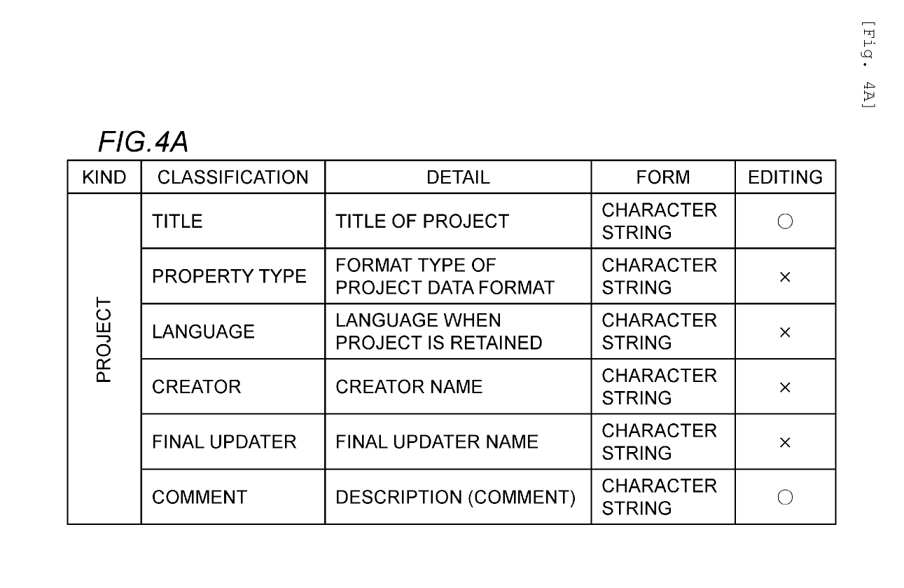

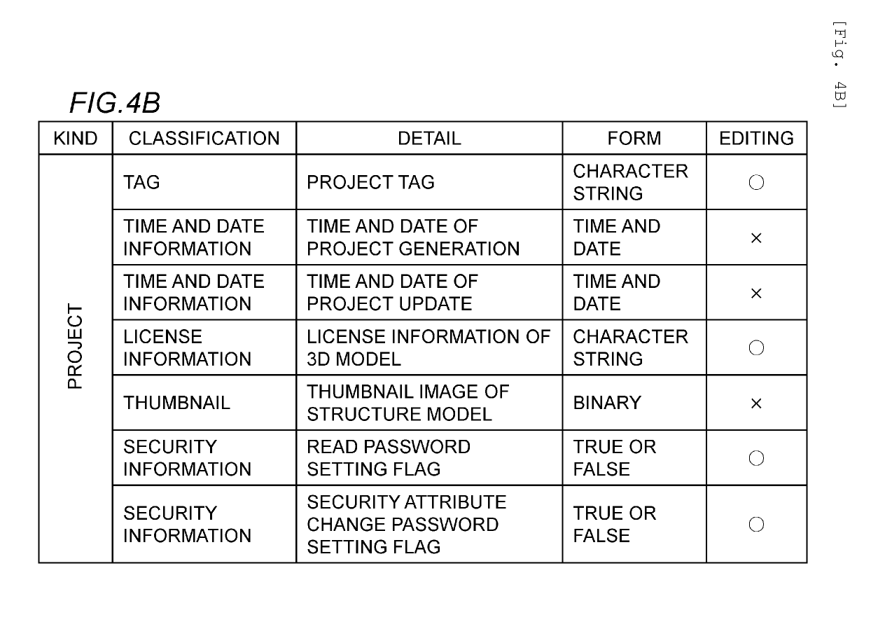

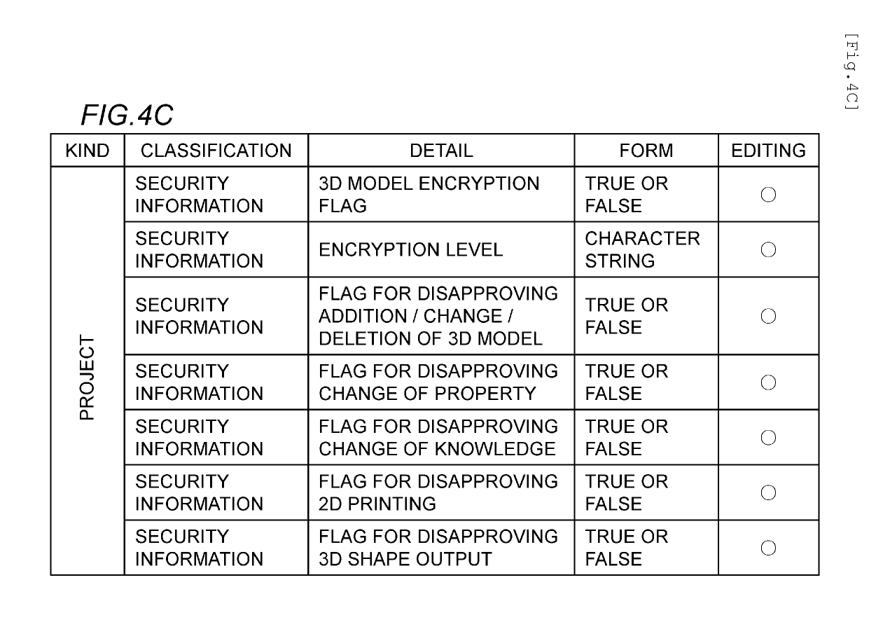

A group of FIGS. 4A to 4C is an example of the property stored in the metadata of the project. “KIND” indicates a scope of data of which the metadata is designated, “CLASSIFICATION” indicates the type of the information of the property, “DETAIL” indicates the item of the property, and “FORM” indicates the data form of the property. “O” in the column of “EDITING” indicates the item that a user can change, and “X” indicates the item that is automatically defined by the 3D data management apparatus 1 and cannot be changed by the user.

“TITLE OF PROJECT” is synonymous with the file name of project data, and is used as a name when this project is distinguished from the other projects. “FORMAT TYPE OF PROJECT DATA FORMAT” is a version number indicative of the format of the property data, and is information for reading the property data of a different version without misunderstanding. “LANGUAGE WHEN PROJECT IS RETAINED” indicates a language used by the user (Japanese, English, or the like). When character strings in the project are read or displayed, a process corresponding to the language is allowed. “CREATOR NAME” is the name of the creator of the project, and “FINAL UPDATER” is the name of a person who has updated the project last. These information items are used in the case where the creator of the project is examined and in the case where the project is retrieved by using the creator. “DESCRIPTION (COMMENT)” is a comment column in which an arbitrary characteristic string can be described by the user. “PROJECT TAG” is an arbitrary character string added by the user. It can be used when the project is retrieved. Note that, by partitioning using a comma, it is possible to set a plurality of tags. “TIME AND DATE OF PROJECT GENERATION” is information on the time and date when the project is newly generated, and “TIME AND DATE OF PROJECT UPDATE” is information on the time and date of the last update of the project. Both of them are used in the case where the project is retrieved/sorted by using the time and date. In “LICENSE INFORMATION OF 3D MODEL”, copyright information of the project data is described. “THUMBNAIL IMAGE OF STRUCTURE MODEL” is a two dimensional image of the structure data (3D data) when the structure data is viewed from a certain angle. This is used in order to quickly confirm the 3D object related to the project.

“SECURITY INFORMATION” is used as a function for protecting the change of the data of the project. The security information, the 3D model, the property, the knowledge, 2D printing, and 3D printing can be individually set. “READ PASSWORD SETTING FLAG” becomes true in the case where “READ PASSWORD” that permits the read of the project is set. “SECURITY ATTRIBUTE CHANGE PASSWORD SETTING FLAG” becomes true in the case where “SECURITY ATTRIBUTE CHANGE PASSWORD” that permits the change of the security information is set. In the case where the 3D data is encrypted, “3D MODEL ENCRYPTION FLAG” becomes true, and the encryption level of the 3D data is described in “ENCRYPTION LEVEL”. Note that the metadata is not encrypted. When “FLAG FOR DISAPPROVING ADDITION/CHANGE/DELETION OF 3D MODEL”, “FLAG FOR DISAPPROVING CHANGE OF PROPERTY”, “FLAG FOR DISAPPROVING CHANGE OF KNOWLEDGE”, “FLAG FOR DISAPPROVING 2D PRINTING”, or “FLAG FOR DISAPPROVING 3D SHAPE OUTPUT” is true, the corresponding process cannot be executed.

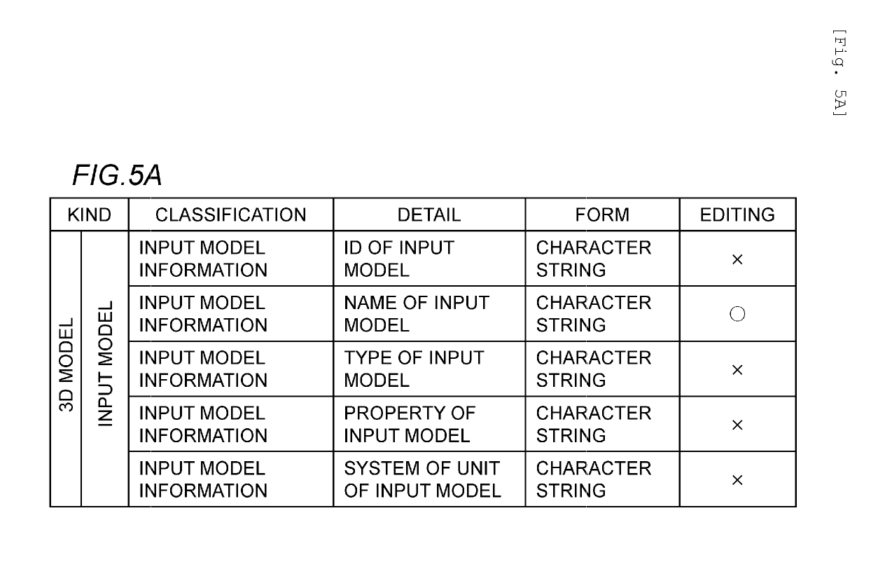

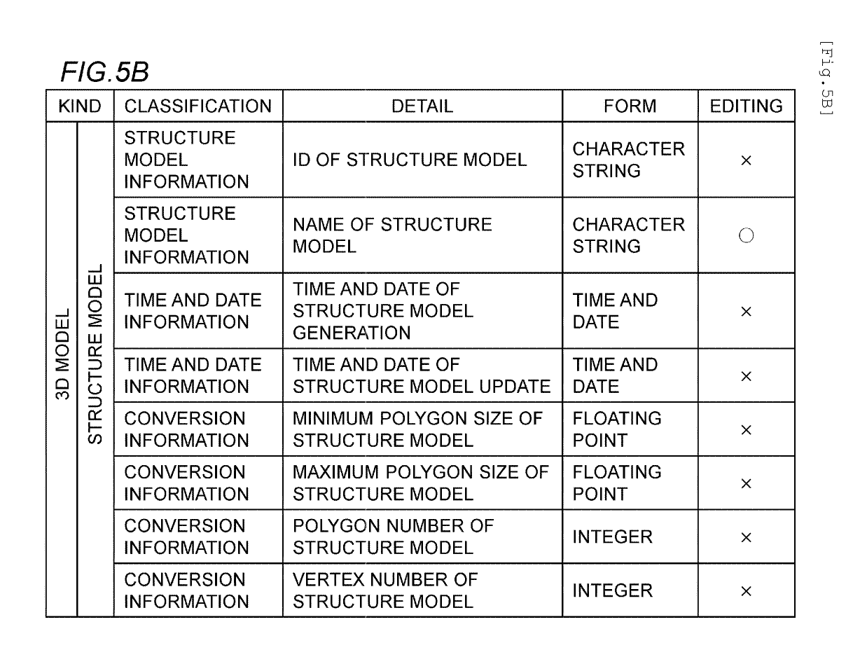

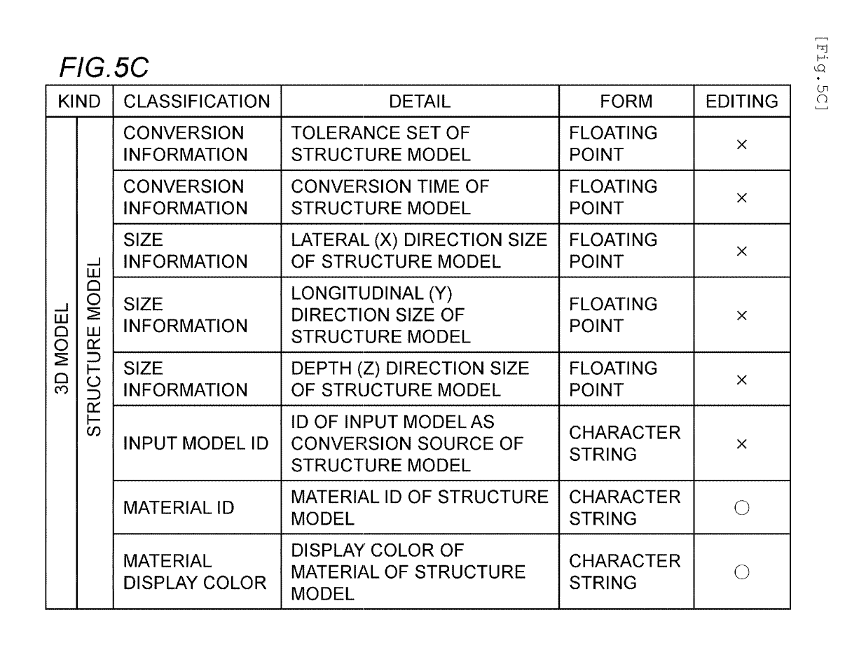

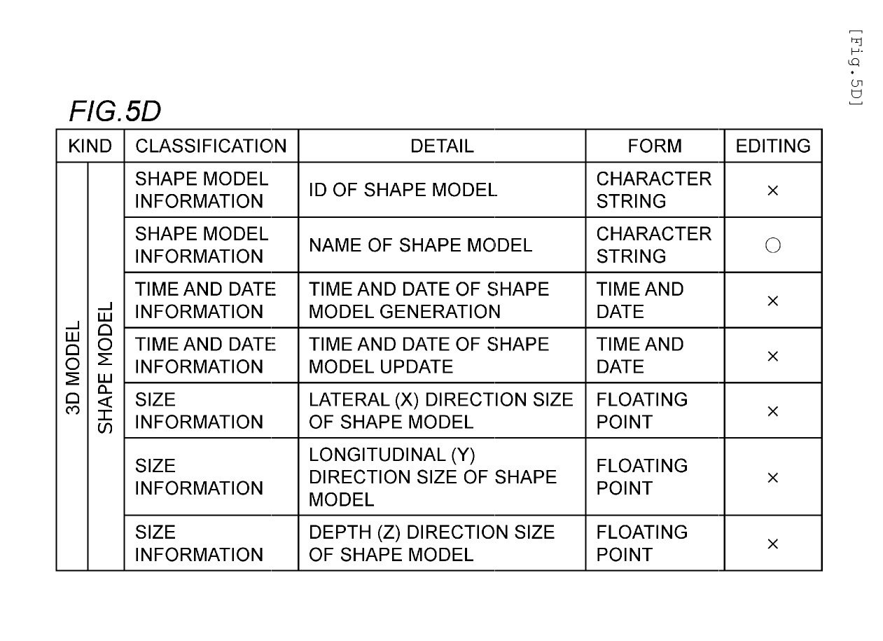

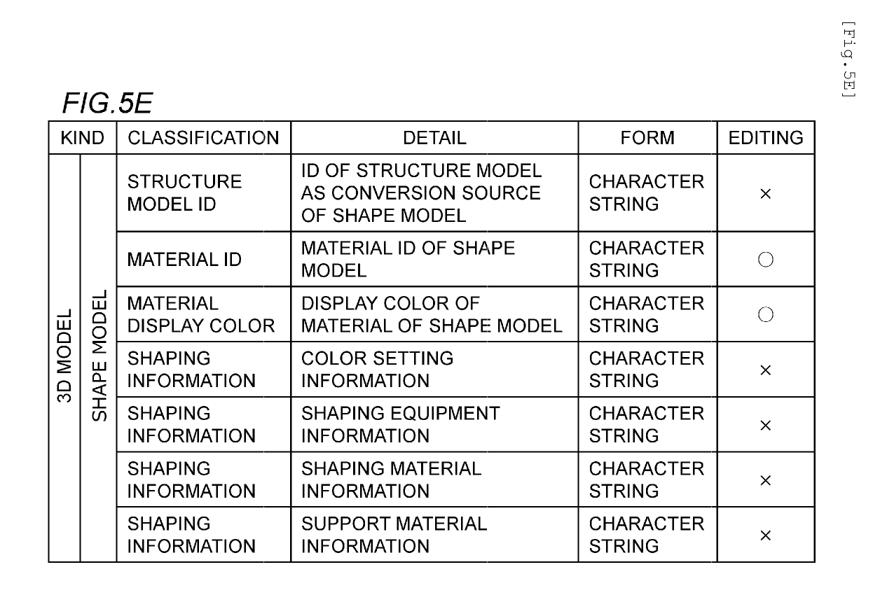

A group of FIGS. 5A to 5E shows an example of the property stored in the metadata of each model. In the metadata of “INPUT MODEL”, “ID OF INPUT MODEL”, “NAME OF INPUT MODEL”, “TYPE OF INPUT MODEL”, “PROPERTY OF INPUT MODEL”, and “SYSTEM OF UNIT OF INPUT MODEL” are stored. These are information items related to the input data, “ID” indicates the file name of the input data, “TYPE” indicates the format of the input data (e.g., the point cloud data, the CAD data, the polygon data, and the like), and “SYSTEM OF UNIT” indicates whether the unit of dimension of the input data is cm or an inch. In “PROPERTY”, the property added to the original input data is copied.

In the metadata of “STRUCTURE MODEL”, “ID OF STRUCTURE MODEL”, “NAME OF STRUCTURE MODEL”, “TIME AND DATE OF STRUCTURE MODEL GENERATION”, and “TIME AND DATE OF STRUCTURE MODEL UPDATE” are stored. “ID OF STRUCTURE MODEL” is the file name of the structure data, and “TIME AND DATE OF STRUCTURE MODEL GENERATION” and “TIME AND DATE OF STRUCTURE MODEL UPDATE” are the time and date of new generation of the structure data and the time and date of last update of the structure data, respectively. In addition, as conversion information, “MINIMUM POLYGON SIZE”, “MAXIMUM POLYGON SIZE”, “POLYGON NUMBER”, “VERTEX NUMBER”, “TOLERANCE SET”, and “CONVERSION TIME” of the structure model are stored. In the tolerance set, various threshold values used for completing the structure data (e.g., the maximum size when hole filling is performed. Internally, used as a parameter of an algorithm) are stored. The conversion time is time required for conversion from the input data to the structure data. The conversion time and the tolerance set are used in order to examine the necessity of the conversion operation and extract “COMMON PROBLEM” of the input data. Further, “LATERAL (X) DIRECTION SIZE”, “LONGITUDINAL (Y) DIRECTION SIZE”, “DEPTH (Z) DIRECTION SIZE”, “ID OF INPUT MODEL AS CONVERSION SOURCE”, “MATERIAL ID”, and “DISPLAY COLOR OF MATERIAL” of the structure model are stored. The material ID and the display color are used in texture mapping and coloring when the structure model is displayed on a screen.

In the metadata of “SHAPE MODEL”, “ID OF SHAPE MODEL”, “NAME OF SHAPE MODEL”, “TIME AND DATE OF SHAPE MODEL GENERATION”, and “TIME AND DATE OF SHAPE MODEL UPDATE” are stored. “ID OF SHAPE MODEL” is the file name of the shape data, and “TIME AND DATE OF SHAPE MODEL GENERATION” and “TIME AND DATE OF SHAPE MODEL UPDATE” are the time and date of new generation of the shape data and the time and date of last update of the shape data, respectively. In addition, “LATERAL (X) DIRECTION SIZE”, “LONGITUDINAL (Y) DIRECTION SIZE”, “DEPTH (Z) DIRECTION SIZE”, “ID OF STRUCTURE MODEL AS CONVERSION SOURCE”, “MATERIAL ID”, and “DISPLAY COLOR OF MATERIAL” of the shape model are also stored. Further, as the shaping information, “COLOR SETTING INFORMATION”, “SHAPING EQUIPMENT INFORMATION”, “SHAPING MATERIAL INFORMATION”, and “SUPPORT MATERIAL INFORMATION” are stored. “COLOR SETTING INFORMATION” is information on the necessity of coloring during the shaping and for designating the color in the case where the coloring is required. “SHAPING EQUIPMENT INFORMATION” is information for identifying the model of the 3D shaping apparatus (an equipment ID, a network address, or the like), and is also information for indicating the specifications and required accuracy of the 3D shaping apparatus. “SHAPING MATERIAL INFORMATION” is information for identifying the material used in the shaping of the 3D object, and “SUPPORT MATERIAL INFORMATION” is information for identifying the material used in the shaping of the support structure.

<Operation of 3D Data Management Apparatus>

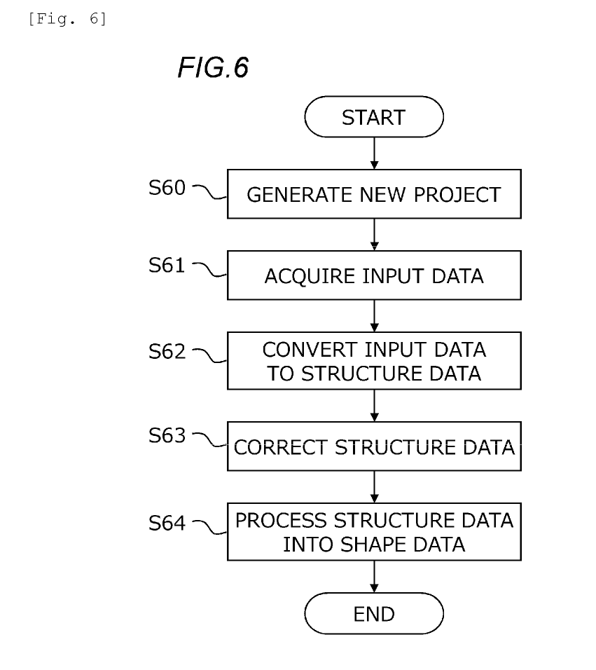

An example of the operation of the 3D data management apparatus 1 will be described with reference to FIG. 6. FIG. 6 is a flowchart showing the flow of processes in which the 3D data management apparatus 1 generates a new project, and generates/registers the input data, the structure data, and shape data sequentially.

Step S60 is a step of generating the new project. For example, a user operates a GUI of the 3D data management apparatus 1 to order “new generation of project” and input the project name. Correspondingly, the project management unit 20 generates a new project file (the file name is identical with the project name) in the storage unit 25. At this point, a configuration may also be adopted in which, by using the project file having a container format, all data related to the project (the 3D data, the metadata, and the like) can be handled as one file (container).

In addition, the project management unit 20 generate the metadata (property) of the project. For example, information items such as, e.g., the format type, the language, the creator name, and the time and data of the generation are automatically registered when the project is newly generated. Further, when the user operates the GUI to input the license information and the security information, these information items are registered in the metadata (property).

Step S61 is a step of acquiring the input data. For example, when the user operates the GUI to order “import of input data” and select the input data to be captured, the data input unit 21 captures the input data. The captured input data is registered in the project by the project management unit 20. Note that the 3D input apparatus such as the 3D scanner may be designated as the import source of the input data. In this case, the data generated in the 3D input apparatus is directly captured by the 3D data management apparatus 1.

There are cases where the 3D data on one object is divided into a plurality of files such as the case where an object is measured from a plurality of directions using the 3D scanner and the case where an object is constituted by a plurality of parts. In these cases, the data input unit 21 captures all of the files and performs a process in which the files are aligned and merged. Note that the data alignment between the files may be automatically performed by the data input unit 21 or may also be performed by the user on an as needed basis.

In addition, the data input unit 21 generates the metadata (property) of the input model. For example, information items such as the ID of the input model (the file name of the input data), the name of the input model, the type (the point cloud data/the CAD data/the polygon data), the property of the input model itself, and the system of unit are automatically registered in the metadata (property). Further, the data input unit 21 registers the operation history of the read process and the alignment/merge process of the input data in the metadata (knowledge).

Step S62 is a step of converting the input data to the structure data. For example, when the user operates the GUI to order “conversion to structure data”, the structure data generation unit 22 refers to the metadata of the input model in the project, and acquires the file name, the type, and the system of unit of the input data. Subsequently, the structure data generation unit 22 reads the input data from the storage unit 25, and converts the input data to the structure data using the conversion algorithm corresponding to the type of the input data. The generated structure data is registered in the project. Note that, with regard to the conversion from the point cloud data or the CAD data to the polygon data, it is possible to use a conventional algorithm, and hence the detailed description thereof will be omitted.

Step S63 is a step of correcting the structure data. For example, the user displays the structure data on a screen and check whether or not intended conversion is performed. In the case where an unintended gap or a stepped part (discontinuous part) is present between planes or a topology error has occurred, the user changes a conversion algorithm or a parameter and performs re-conversion of the data. Examples of the parameter that can be changed include the minimum polygon size, the maximum polygon size, and the tolerance (threshold value).

As an example in which the tolerance is changed, “hole filling of object surface” will be described. The hole filling of the object surface is a process for filling (covering with the polygon) a hole smaller than a size (diameter) set by the tolerance (threshold value). With this process, it is possible to facilitate shaping by converting a structure having a fine hole to a simple plane, and automatically repair a minute gap resulting from a scanning mistake. For example, in the case where an unintended hole or gap remains in the object surface when the structure data generated first is checked, it is possible to remove the unneeded gap or hole by changing the tolerance (threshold value) that defines the hole filling size and performing re-conversion.

Note that, in the case where the problem cannot be solved only by changing the conversion algorithm or parameter, it is also possible to partially correct the input data or the structure data by using an editing tool provided by the structure data generation unit 22. Alternatively, after exporting the input data or the structure data from the project and converting or correcting the input data or the structure data by using a tool of another system or utility software attached to the 3D shaping apparatus or the like, the data may be imported to the project.

When the generation of the structure data is completed, the structure data generation unit 22 generates the metadata (property) of the structure model. For example, information items such as the ID of the structure model (the file name of the structure data), the name of the structure model, the time and date of the generation, various conversion information items, size information, and the input model ID of the original input data are automatically registered in the metadata (property). The user can operate the GUI to register the information items such as the material ID and the display color of the structure model. In addition, the structure data generation unit 22 generates the two dimensional image of the structure data when the structure data is viewed from a certain angle (the front, obliquely from above, and the like), and registers the data thereof in the thumbnail of the metadata (property) of the project. Further, the structure data generation unit 22 registers the operation history of the conversion process and correction process of the structure data in the metadata (knowledge). For example, in the case where the parameter such as the tolerance is adjusted many times and the re-conversion is repeated, information items such as the value of the parameter and the conversion result (remaining problem) in each re-conversion are registered as the history.

Step S64 is a step of processing the structure data into the shape data. For example, the user operate the GUI to designate a 3D shaping apparatus to which the shape data is to be output and order “generation of shape data”. Correspondingly, the shape data generation unit 23 reads information items such as the required specifications of the designated 3D shaping apparatus and shaping conditions and the structure data from the storage unit 25, and performs necessary processing on the structure data to generate the shape data. For example, when a part without a wall thickness (a part having only a plane) or a part that is too thin to meet the required strength of the 3D shaping apparatus is detected, the shape data generation unit 23 performs processing of giving a necessary thickness to the corresponding part. In addition, when it is determined that the support structure for supporting the overhanging part is necessary, the shape data generation unit 23 adds polygon data representing the support structure to the shape data. Alternatively, in the case of an object having a hollow structure, the shape data generation unit 23 performs a process for forming the lightening hole for removing the material in the hollow part after the shaping. Further, the shape data generation unit 23 is capable of describing the parameter used in the 3D shaping apparatus during the shaping in the shape data. The generated shape data is registered in the project.

When the generation of the shape data is completed, the shape data generation unit 23 generates the metadata (property) of the shape model. For example, the ID of the shape model (the file name of the shape data), the name of the shape model, the time and date of the generation, the size information, the model ID of the original structure data, and the shaping information are automatically registered in the metadata (property). In addition, the user can operate the GUI to register information items such as the material ID and the display color of the shape model. Further, the shape data generation unit 23 registers the operation history of the processing process of the shape data in the metadata (knowledge).

Note that the user can use the GUI provided by the project management unit 20 to update the metadata (the property and the knowledge that can be edited) in the project at any time. It is preferable to record information items such as, e.g., things that the user has noticed, the problem that has occurred, and the solution method of the problem that has been solved in each of operations such as the acquisition/the merge of the input data, the conversion/the correction of the structure data, and the processing of the shape data in the knowledge.

<Advantage>

The 3D data management apparatus 1 and the project data of the present embodiment have the following advantages. The information related to the three dimensional structure of the object is collectively managed in one project, and hence the use and management of the data are facilitated. In particular, all of the original data on the object (input data), the data representing the three dimensional structure of the object surface (structure data), and the data for output that depends on the device (shape data) remain, and hence it is easy to utilize and expand the data. For example, in the case where the data is output to another 3D shaping apparatus, it is possible to create new shape data from the structure data, and hence it is possible to significantly reduce the process cost as compared with the case where the new shape data is re-created from the point cloud data or the CAD data as in the conventional case. In addition, it is possible to use and confirm the detail of the previously performed operation (e.g., the algorithm and the parameter used in the conversion from the input data to the structure data) by referring to the metadata, and hence it is possible to increase working efficiency.

In addition, even when an inadequacy in data is found during the shaping in the 3D shaping apparatus, it is possible to re-execute the operation from a midway stage (not from the point cloud data or the CAD data). For example, when the inadequacy in data is “insufficient strength (wall thickness is extremely thin)”, it is clear that the structure data has no problem, and hence it is only necessary to perform the re-creation of the shape data.

Further, it is possible to easily perform the conversion and processing of the 3D data even without high-level knowledge or skill by using the 3D data management apparatus 1, and also easily generate the shape data suitable (meeting requirements in shaping) for the 3D shaping apparatus to which the shape data is to be output.

In addition, the history information of the conversion, correction, and processing of the data that is recorded as the knowledge is expected to have various applications. For example, when a bottle having a hole (opening) in its upper part is measured using the 3D scanner, the bottle is read as a shape having a hole in its upper part (the wall thickness of the bottle is not read). When the diameter of the hole is smaller than the tolerance (threshold value) at the time of conversion of the point cloud data to structure data, the hole is filled, and data in the shape of a bar is obtained. When the diameter of the hole is larger than the tolerance, data in the shape of a bottle that has the hole and has a wall thickness of zero is obtained. The choice of the structure data depends on the user, and hence the user adjusts the tolerance to an appropriate value such that the data in an intended shape can be obtained. Such a series of histories are recorded in the knowledge. As a result, the user can reuse the value of the tolerance with which process efficiency is excellent (the intended result can be obtained) by referring to the previously recorded knowledge when the user handles data on another object having a hole. Alternatively, when many data items on the object having the hole are accumulated, the value of the frequently used tolerance can be found by referring to the knowledge thereof, and hence it becomes possible to automatically optimize the value of the tolerance and recommend the appropriate value of the tolerance to the user.

<Other Embodiments>

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)Tm), a flash memory device, a memory card, and the like.

According to the present invention, it is possible to improve the convenience in the use and management of the 3D data.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-048190, filed on Mar. 11, 2015, which is hereby incorporated by reference herein in its entirety.

1. A non-transitory computer-readable medium storing a data structure of a 3D object for managing information related to a three dimensional structure of an object, comprising:
input data as data on the 3D object generated by a 3D input apparatus;
structure data as data representing the three dimensional structure of the 3D object that is generated from the input data; and
shape data as data obtained by performing, on the structure data, processing required to meet a required specification of a specific 3D shaping apparatus.

2. The non-transitory computer-readable medium according to claim 1, wherein the data structure of a 3D object further comprises metadata including information on a parameter used in a process for generating the structure data from the input data.

3. The non-transitory computer-readable medium according to claim 2, wherein the metadata includes history information of an operation of generating the structure data from the input data.

4. The non-transitory computer-readable medium according to claim 2, wherein the metadata includes comment information input by a user.

5. The non-transitory computer-readable medium according to claim 2, wherein the metadata includes data on a two dimensional image of the structure data when the structure data is viewed from a certain angle.

6. The non-transitory computer-readable medium according to claim 1, wherein the input data is data obtained by measuring the 3D object using a 3D scanner serving as the 3D input apparatus, or data generated by a 3D CAD or a 3D modeler serving as the 3D input apparatus.

7. The non-transitory computer-readable medium according to claim 1, wherein the structure data is data in which the three dimensional structure of the 3D object is represented by a polygon.

8. The non-transitory computer-readable medium object according to claim 7, wherein the structure data is data in which a structural fault in the three dimensional structure of the 3D object is corrected.

9. The non-transitory computer-readable medium data structure of a 3D object according to claim 1, wherein the shape data is data in which a part that does not meet a required strength of the specific 3D shaping apparatus in the three dimensional structure of the 3D object has been subjected to processing of giving a thickness required to meet the required strength.

10. The non-transitory computer-readable medium according to claim 1, wherein the shape data is data in which a support structure for supporting an overhanging part in the three dimensional structure of the 3D object is added to the overhanging part.

11. A 3D data management apparatus, which manages information related to a three dimensional structure of a 3D object by using a data structure of a 3D object, the data structure comprising:
input data as data on the 3D object generated by a 3D input apparatus;
structure data as data representing the three dimensional structure of the 3D object that is generated from the input data; and
shape data as data obtained by performing, on the structure data, processing required to meet a required specification of a specific 3D shaping apparatus.

12. The 3D data management apparatus according to claim 11, comprising:
a shape data generation unit that generates the shape data from the structure data; and
a storage unit that stores a table in which respective required specifications of a plurality of 3D shaping apparatuses are defined, wherein
the shape data generation unit:
reads, based on designation of a 3D shaping apparatus to which the shape data is to be output, the required specification of the designated 3D shaping apparatus from the storage unit;
and
generates the shape data by performing, on the structure data, processing required to meet the required specification of the designated 3D shaping apparatus.
